(19) United States
(12) Patent Application Publication
(10) Pub. No.: US 2022/0385775 A1
(43) Pub. Date: Dec. 1, 2022

(54) MULTIFUNCTION MACHINE, DISPLAY CONTROL METHOD FOR MULTIFUNCTION MACHINE, AND NON-TRANSITORY COMPUTER-READABLE STORAGE MEDIUM

(71) Applicant: SEIKO EPSON CORPORATION, Tokyo (JP)

(72) Inventor: Ken IKUMA, Suwa, (JP)

(21) Appl. No.: 17/664,884

(22) Filed: May 25, 2022

(30) Foreign Application Priority Data
May 27, 2021 (JP) 2021-089072

(51) Int. Cl. H04N 1/00

(52) U.S. Cl. CPC H04N 1/00424; H04N 1/00461

(57) ABSTRACT

A multifunction machine includes a reading unit that reads a document, a printing unit that performing printing on a medium, and an operation panel that receives a user operation to display a first operation face including a plurality of icons and a first background image and a second operation face including a plurality of icons and a second background image, wherein the first operation face and the second operation face are switched based on the user operation, and wherein the first background image is different from the second background image.

The present application is based on, and claims priority from JP Application Serial Number 2021-089072, filed May 27, 2021, the disclosure of which is hereby incorporated by reference herein in its entirety.

### BACKGROUND

### 1. Technical Field

The present disclosure relates to a multifunction machine, a method of controlling a display of the multifunction machine, and a non-transitory computer-readable storage medium storing a display control program.

### 2. Related Art

In the related art, a multifunction machine having a plurality of functions such as a scanning function, a printing function, and a copying function has been known. The multifunction machine includes an operation panel for instructing various settings and execution of various functions. JP-A-2016-157156 describes an image forming apparatus that is a multifunction machine in which a plurality of initial screens in which icons are disposed are displayed on an operation panel and the plurality of initial screens is switched by a user operation. The multifunction machine including an operation panel for switching between a plurality of initial screens can arrange many icons on the operation panel.

However, when the operation screen, which is composed of a plurality of initial screens, is displayed on the operation panel by switching the plurality of initial screens, it is difficult for the user to understand which of the plurality of initial screens the displayed initial screen is, and the operability is deteriorated.

### SUMMARY

According to an aspect of the present disclosure, a multifunction machine includes a reading unit that reads a document, a printing unit that performing printing on a medium, an operation panel that receives a user operation to display a first operation face including a plurality of icons and a first background image and a second operation face including a plurality of icons and a second background image, and a display controller that controls a display of the operation panel, wherein the display controller switches between the first operation face and the second operation face based on the user operation, and wherein the display controller makes the first background image and the second background image different from each other.

According to another aspect of the present disclosure, in a method of controlling a display of a multifunction machine including an operation panel, the method includes displaying a first operation face including a plurality of icons and a first background image, receiving a user operation to switch an operation face from the first operation face to a second operation face including a plurality of icons and a second background image different from the first background image, and displaying the second operation face on the operation panel.

According to still another aspect of the present disclosure, in a non-transitory computer-readable storage medium storing a display control program, where the display control program causes a processor of a multifunction machine including an operation panel that displays an operation face to execute a method, the method includes displaying, as the operation face, a first operation face including a plurality of icons and a first background image on the operation panel, receiving a user operation to switch the operation face of the operation panel from the first operation face to a second operation face including a plurality of icons and a second background image different from the first background image, and displaying the second operation face on the operation panel.

### BRIEF DESCRIPTION OF THE DRAWINGS

FIG. 1 is a diagram showing an outline of a multifunction machine.

FIG. 2 is a diagram showing a functional block of a multifunction machine.

FIG. 3 is a diagram showing a first operation screen displayed on an operation panel.

FIG. 4 is a diagram showing a second operation screen displayed on the operation panel.

FIG. 5 is a diagram showing a third operation screen displayed on the operation panel.

FIG. 6 is a diagram showing a flowchart when switching operation screens.

FIG. 7 is a diagram showing a first operation screen displayed on the operation panel.

FIG. 8 is a diagram showing a second operation screen displayed on the operation panel.

FIG. 9 is a diagram showing a first operation screen displayed on the operation panel.

FIG. 10 is a diagram showing a second operation screen displayed on the operation panel.

FIG. 11 is a diagram showing a third operation screen displayed on the operation panel.

### DESCRIPTION OF EXEMPLARY EMBODIMENTS

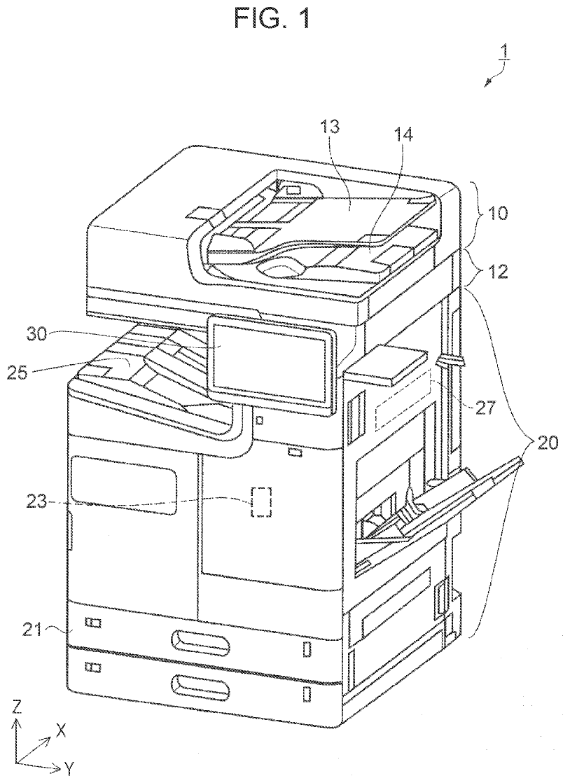

FIG. 1 is a perspective view showing an outline of a multifunction machine 1. The multifunction machine 1 includes a reading unit 10 that reads a document, a printing unit 20 that performs printing, and an operation panel 30. The multifunction machine 1 has a print function of performing printing on a medium and a copy function of reading a document and printing the read data on the medium. The multifunction machine 1 may have a scanning function of reading a document to generate and store read data, or a fax function of faxing read data or data received from the outside. The fax function has a function of receiving fax data from the outside. The multifunction machine 1 may have a call function for making a call or an email function that transmits an email.

The reading unit 10 is mounted on a reading unit mounting table 12. The reading unit 10 includes a placement tray 13 on which documents are placed, and a document discharge tray 14 on which documents transported along the transport path are discharged. The reading unit 10 transports the document placed on the placement tray 13 to the document discharge tray 14 along the transport path. A reading sensor (not shown) is provided in the transport path of the reading unit 10. The reading sensor reads an image formed on the document. The reading unit 10 corresponds to a reader.

The printing unit 20 includes a paper feeding cassette 21 on which a medium is placed, a printing mechanism 23, and a printed matter discharge tray 25 that discharges the medium on which the printing mechanism 23 performs printing. The printing mechanism 23 of the present embodiment is an ink jet recording head that ejects ink to a medium for recording, but a mechanism other than the ink jet recording head may be used.

The printing unit 20 may optionally include a post-processing mechanism (not shown). The post-processing mechanism performs various processes on the printed matter printed by the printing unit 20. Examples of the process executed by the post-processing mechanism include a staple process for binding a plurality of pieces of printed matter with needles, a punching process for making holes in the printed matter, a folding process for folding the printed matter in half, and a shifting process for discharging a plurality of pieces of printed matter by shifting them for each set thereof. The post-processing mechanism performs one or a plurality of these processes.

The operation panel 30 displays various icons 110. The icon 110 is an image displayed on the operation panel 30. The icon 110 is an image for receiving an execution instruction described later. The plurality of icons 110 displayed on the operation panel 30 is away separated from each other. Details of the icon 110 will be described later. The operation panel 30 is a touch panel that receives touch operations by the user. The operation panel 30 switches between an operation screen 100, which will be described later, and an edit screen (not shown).

The multifunction machine 1 includes a processor 27 inside the housing. The processor 27 reads and executes various programs stored in a memory 40 described later. The processor 27 executes various programs and performs various kinds of control.

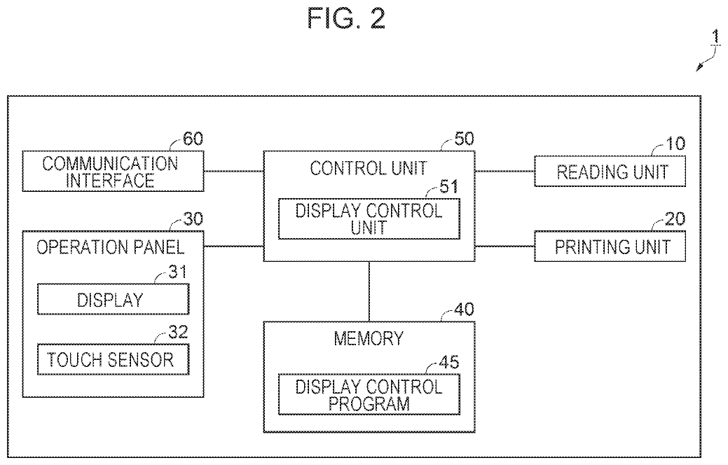

FIG. 2 shows a functional block of the multifunction machine 1. The multifunction machine 1 includes the reading unit 10, the printing unit 20, the operation panel 30, the memory 40, a control unit 50, and a communication interface 60.

The operation panel 30 includes a display 31 and a touch sensor 32. The display 31 is composed of a panel such as a liquid crystal panel, an organic EL (electroluminescence), and displays the operation screen 100, an edit screen, and the like. The touch sensor 32 detects various touch operations input by the user. The operation panel 30 corresponds to a display unit.

The memory 40 stores various programs such as a read control program that controls the operation of the reading unit 10, a print control program that controls the operation of the printing unit 20, and a display control program 45 that controls the display of the operation panel 30. The program may consist of one or more packages. The memory 40 stores various pieces of data. The display control program 45 controls various types of displays displayed on the operation panel 30, such as control for switching between the operation screen 100 and the edit screen, control for switching between a plurality of the operation screens 100, and control for changing a display mode of the icon 110 selected on the edit screen. The display control program 45 corresponds to an example of a control program. The memory 40 is composed of a semiconductor storage element such as a flash read only memory (ROM) or another type of non-volatile storage device. The memory 40 may include a random access memory (RAM) constituting a work area. The memory 40 may be configured by a magnetic storage device such as a hard disk drive (HDD) or a semiconductor storage device such as a solid state drive (SSD).

The control unit 50 controls each part of the multifunction machine 1. The control unit 50 is a controller including the processor 27. The control unit 50 executes the program stored in the memory 40. The control unit 50 receives various instructions based on the touch operation by the user input to the touch sensor 32 of the operation panel 30. The control unit 50 controls the reading unit 10, the printing unit 20, the operation panel 30, and the communication interface 60 based on the received instructions. The control unit 50 corresponds to a controller.

The control unit 50 includes a display control unit 51. The display control unit 51 is a functional unit the function of which is implemented by the control unit 50 executing the display control program 45. The display control unit 51 controls the operation panel 30 and controls the display mode of the image to be displayed on the display 31. The display control unit 51 receives various instructions based on the touch operation by the user input to the touch sensor 32. The display control unit 51 performs the process on the icon 110 displayed on the display 31 of the operation panel 30 based on the received instruction. The processing for the icon 110 is selection, editing, or the like. The display control unit 51 controls the display or non-display of the edited icon 110.

The display control unit 51 controls switching between the plurality of operation screens 100 based on the received instruction. The display control unit 51 displays the operation screen 100 selected by the user on the display 31 by controlling the switching of the plurality of operation screens 100. The display control unit 51 corresponds to a display controller. The plurality of operation screens 100 include the n-th operation screen. n is an integer of 1 or more.

The display control unit 51 displays a background image 115, which will be described later, in the operation screen 100, to which will be described later. Each of the plurality of operation screens 100 displays the background image 115. The n-th operation screen displays the n-th background image. The display control unit 51 edits the background image 115 based on the instruction based on the user operation. Editing the background image 115 includes changing, modifying, and processing the image used for the background image 115. Editing the background image 115 includes changing the display mode such as color, brightness, and pattern. The display control unit 51 edits the background image 115 for each operation screen 100 to store the edited background image 115 in the memory 40. When the operation screen 100 is switched, the display control unit 51 reads out the background image 115 stored in the memory 40 and displays the read background image on the operation panel 30.

The communication interface 60 communicates with an external device (not shown), transmits the output data output from the control unit 50 to the external device, and receives the input data from the external device. Examples of the external device include server devices such as a cloud server and an email server, a personal computer, a smartphone, and the like. The communication interface 60 may be a wired connection via a cable, or may be a wireless connection according to an Ethernet (registered trademark) standard or the like. When the multifunction machine 1 has a fax function or a call function, the communication interface 60 is connected to a telephone line. When the multifunction machine 1 is connected to a cloud server or an email server, the communication interface 60 is connected to an Internet communication network.

### First Embodiment

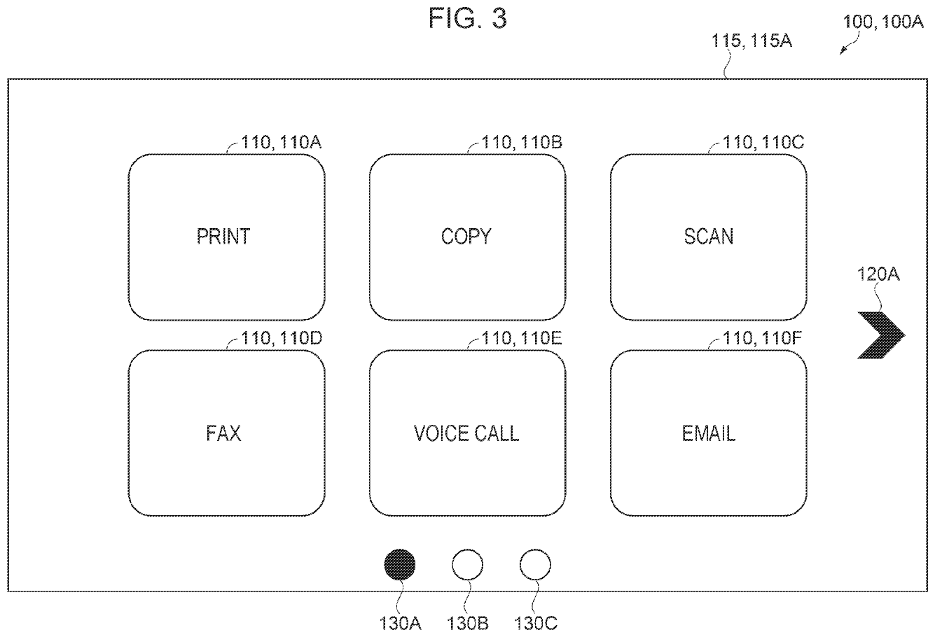

FIGS. 3 to 5 show the operation screen 100 of the first embodiment. FIG. 3 shows a first operation screen 100A displayed on the operation panel 30. The first operation screen 100A is an example of the operation screen 100, and is one of the plurality of operation screens 100. The operation screen 100 corresponds to an operation face. The first operation screen 100A corresponds to an example of a first operation face.

The first operation screen 100A displays the plurality of icons 110, a first background image 115A, a first screen switching instruction icon 120A, a first position icon 130A, a second position icon 130B, and a third position icon 130C. The plurality of icons 110 is a print execution icon 110A, a copy execution icon 110B, a scan execution icon 110C, a fax execution icon 110D, a voice call icon 110E, and an email execution icon 110F.

The print execution icon 110A receives a printing instruction based on the touch operation when the user performs a touch operation. The operation panel 30 transmits the received printing instruction to the control unit 50. Upon receiving the printing instruction, the control unit 50 transmits the printing instruction to the printing unit 20, and the printing unit 20 performs printing based on the printing instruction. When the user performs a touch operation on the print execution icon 110A, the display control unit 51 may display the print setting screen for setting the print conditions on the operation panel 30.

When the user performs a touch operation, the copy execution icon 110B receives a copy instruction based on the touch operation. The operation panel 30 transmits the received copy instruction to the control unit 50. Upon receiving the copy instruction, the control unit 50 transmits the copy instruction to the reading unit 10 and the printing unit 20. The reading unit 10 reads the document based on the copy instruction to generate the read data. The printing unit 20 prints the read data based on the copy instruction. When the user performs a touch operation on the copy execution icon 110B, the display control unit 51 may display the copy setting screen for setting the copy condition on the operation panel 30.

When the user performs a touch operation, the scan execution icon 110C receives a reading instruction based on the touch operation. The operation panel 30 transmits the received reading instruction to the control unit 50. Upon receiving the reading instruction, the control unit 50 transmits the reading instruction to the reading unit 10. The reading unit 10 scans the document based on the reading instruction to generate read data. The generated read data is stored in the memory 40. The control unit 50 may transmit the read data to the external device via the communication interface 60. When the user performs a touch operation on the scan execution icon 110C, the display control unit 51 may display a reading setting screen for setting reading conditions on the operation panel 30.

The fax execution icon 110D is displayed when the multifunction machine 1 has a fax function. When the user performs a touch operation, the fax execution icon 110D receives a fax instruction based on the touch operation. The operation panel 30 transmits the received fax instruction to the control unit 50. Upon receiving the fax instruction, the control unit 50 transmits data to the external device via the communication interface 60. When the user performs touch operation on the fax execution icon 110D, the display control unit 51 may display a fax setting screen for setting a fax communication condition or a fax transmission destination.

The voice call icon 110E is displayed when the multifunction machine 1 has a call function. When the user performs a touch operation, the voice call icon 110E receives a call instruction based on the touch operation. The operation panel 30 transmits the received call instruction to the control unit 50. Upon receiving the call instruction, the control unit 50 perform transmission to a person to be call who is preset via the communication interface 60. When the user performs a touch operation on the voice call icon 110E, the display control unit 51 may display the call destination setting screen for setting the call destination.

The email execution icon 110F is displayed when the multifunction machine 1 has an email function. When the user performs a touch operation, the email execution icon 110F receives an email instruction based on the touch operation. The operation panel 30 transmits the received email instruction to the control unit 50. Upon receiving the email instruction, the control unit 50 transmits an email to a preset transmission destination via the communication interface 60. When the user performs a touch operation on the email execution icon 110F, the display control unit 51 may display the transmission destination setting screen for setting the transmission destination.

The first background image 115A is an image displayed as the background of the plurality of icons 110. The first background image 115A is associated with the first operation screen 100A and is stored in the memory 40. The first background image 115A can be edited by the user. The first background image 115A is an example of the background image 115, and is one of a plurality of background images 115. The first background image 115A corresponds to an example of a first background image.

When the user performs a touch operation, the first screen switching instruction icon 120A receives a switching instruction of the operation screen 100. The first screen switching instruction icon 120A receives a switching instruction instructing switching from the first operation screen 100A to a second operation screen 100B.

The first position icon 130A, the second position icon 130B, and the third position icon 130C represent the operation screen 100 displayed on the operation panel 30 among the plurality of operation screens 100. The first position icon 130A in FIG. 3 indicates that the first operation screen 100A is displayed. FIG. 3 shows the first position icon 130A, the second position icon 130B, and the third position icon 130C, but the present disclosure is not limited to this. The display can be changed according to the number of operation screens 100 that can be displayed.

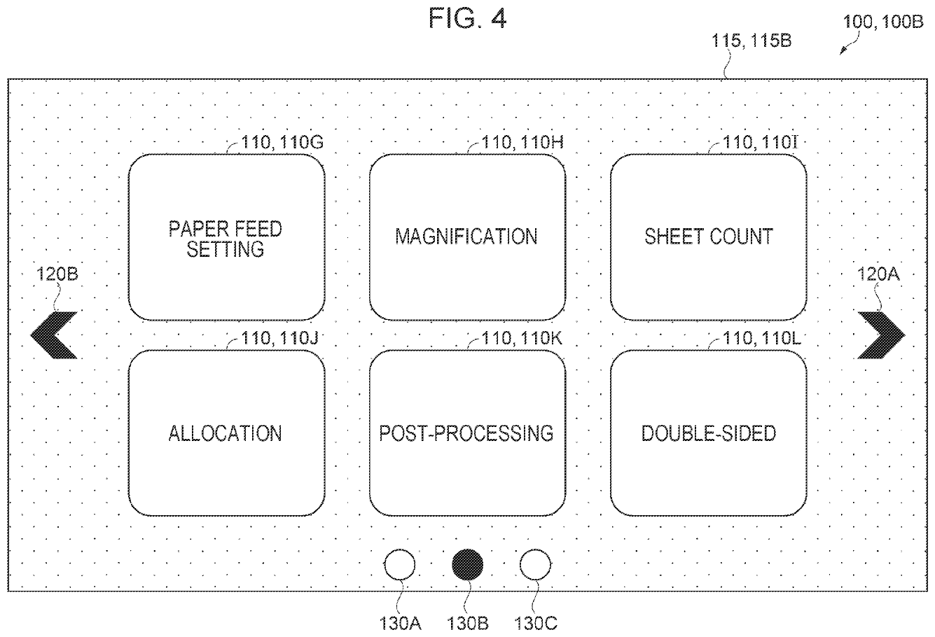

FIG. 4 shows a second operation screen 100B displayed on the operation panel 30. The second operation screen 100B is an example of the operation screen 100, and is one of the plurality of operation screens 100. The second operation screen 100B corresponds to an example of a second operation face.

The second operation screen 100B displays the plurality of icons 110, a second background image 115B, the first screen switching instruction icon 120A, a second screen switching instruction icon 120B, the first position icon 130A, the second position icon 130B, and the third position icon 130C. The plurality of icons 110 are a paper feed setting icon 110G, a magnification setting icon 110H, a sheet count setting icon 110I, an allocation setting icon 110J, a post-processing setting icon 110K, and a double-sided setting icon 110L.

When the user performs a touch operation, the paper feed setting icon 110G receives a paper feed setting instruction based on the touch operation. When the user performs a touch operation on the paper feed setting icon 110G, the display control unit 51 displays the paper feed setting screen for setting the paper feed conditions on the operation panel 30.

When the user performs a touch operation, the magnification setting icon 110H receives a magnification setting instruction based on the touch operation. When the user performs a touch operation on the magnification setting icon 110H, the display control unit 51 displays a magnification setting screen for setting the copy magnification on the operation panel 30.

When the user performs a touch operation, the sheet count setting icon 110I receives a sheet count setting instruction based on the touch operation. When the user performs a touch operation on the sheet count setting icon 110I, the display control unit 51 may display the sheet count setting screen for setting the number of copies on the operation panel 30.

When the user performs a touch operation, the allocation setting icon 110J receives an allocation setting instruction based on the touch operation. When the user performs a touch operation on the allocation setting icon 110J, the display control unit 51 displays the allocation setting screen for setting the allocation condition.

The post-processing setting icon 110K is displayed when the multifunction machine 1 includes a post-processing mechanism. When the user performs a touch operation, the post-processing setting icon 110K receives a post-processing setting instruction based on the touch operation. When the user performs a touch operation on the post-processing setting icon 110K, the display control unit 51 displays the post-processing setting screen for setting the post-processing conditions.

When the user performs a touch operation, the double-sided setting icon 110L receives a double-sided printing instruction based on the touch operation. The operation panel 30 transmits the received double-sided printing instruction to the control unit 50. Upon receiving the double-sided printing instruction, the control unit 50 transmits the double-sided printing instruction to the printing unit 20. The printing unit 20 performs double-sided printing based on the double-sided printing instruction. When the user performs a touch operation on the double-sided setting icon 110L, the display control unit 51 may display the double-sided printing setting screen for setting the double-sided printing conditions.

The second background image 115B is an image displayed as the background of the plurality of icons 110. The second background image 115B is associated with the second operation screen 100B and is stored in the memory 40. The second background image 115B can be edited by the user. The second background image 115B is an example of the background image 115, and is one of a plurality of background images 115. The second background image 115 corresponds to an example of a second background image.

The first screen switching instruction icon 120A displayed on the second operation screen 100B is the same as the first screen switching instruction icon 120A displayed on the first operation screen 100A.

When the user performs a touch operation, the second screen switching instruction icon 120B receives the switching instruction of the operation screen 100. The second screen switching instruction icon 120B receives a switching instruction instructing switching from the second operation screen 100B to the first operation screen 100A.

The first position icon 130A, the second position icon 130B, and the third position icon 130C represent the operation screen 100 displayed on the operation panel 30 among the plurality of operation screens 100. The second position icon 130B in FIG. 4 indicates that the second operation screen 100B is displayed.

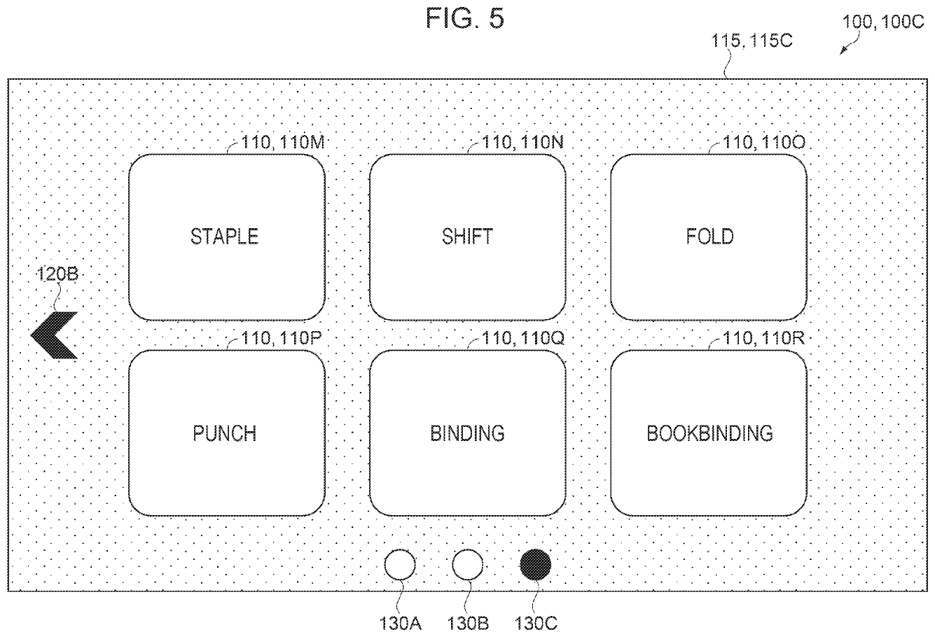

FIG. 5 shows a third operation screen 100C displayed on the operation panel 30. The third operation screen 100C is an example of the operation screen 100, and is one of a plurality of operation screens 100. The third operation screen 100C corresponds to an example of a third operation face.

The third operation screen 100C displays the plurality of icons 110, a third background image 115C, the second screen switching instruction icon 120B, the first position icon 130A, the second position icon 130B, and the third position icon 130C. The plurality of icons 110 are a staple setting icon 110M, a shift setting icon 110N, a folding setting icon 110O, a punch setting icon 110P, a binding setting icon 110Q, and a bookbinding setting icon 110R. The staple setting icon 110M, the shift setting icon 110N, the folding setting icon 110O, the punch setting icon 110P, the binding setting icon 110Q, and the bookbinding setting icon 110R are displayed when the multifunction machine 1 includes a post-processing mechanism.

When the user performs a touch operation, the staple setting icon 110M receives a staple setting instruction based on the touch operation. When the user performs a touch operation on the staple setting icon 110M, the display control unit 51 displays a staple setting screen for setting staple conditions such as the staple position on the operation panel 30.

When the user performs a touch operation, the shift setting icon 110N receives a shift setting instruction based on the touch operation. When the user performs a touch operation on the shift setting icon 110N, the display control unit 51 displays a shift setting screen for setting execution conditions for shift processing such as a shift amount on the operation panel 30.

When the user performs a touch operation, the folding setting icon 110O receives a fold setting instruction based on the touch operation. When the user performs a touch operation on the folding setting icon 110O, the display control unit 51 may display the fold setting screen for setting the fold method such as the fold position on the operation panel 30.

When the user performs a touch operation, the punch setting icon 110P receives a punch setting instruction based on the touch operation. When the user performs a touch operation on the punch setting icon 110P, the display control unit 51 displays a punch setting screen for setting punch conditions such as the punch position.

When the user performs a touch operation, the binding setting icon 110Q receives a binding setting instruction based on the touch operation. When the user performs a touch operation on the binding setting icon 110Q, the display control unit 51 displays the binding setting screen for setting the binding conditions such as the binding method.

When the user performs a touch operation, the bookbinding setting icon 110R receives a bookbinding setting instruction based on the touch operation. When the user performs a touch operation on the bookbinding setting icon 110R, the display control unit 51 displays the bookbinding setting screen for setting the bookbinding conditions such as the bookbinding method.

The third background image 115C is an image displayed as the background of the plurality of icons 110. The third background image 115C is associated with the third operation screen 100C and is stored in the memory 40. The third background image 115C can be edited by the user. The third background image 115C is an example of the background image 115, and is one of a plurality of background images 115. The third background image 115 corresponds to an example of a third background image.

The second screen switching instruction icon 120B displayed on the third operation screen 100C is the same as the second screen switching instruction icon 120B displayed on the second operation screen 100B.

The first position icon 130A, the second position icon 130B, and the third position icon 130C represent the operation screen 100 displayed on the operation panel 30 among the plurality of operation screens 100. The third position icon 130C in FIG. 5 indicates that the third operation screen 100C is displayed.

In FIGS. 3, 4, and 5, the first operation screen 100A, the second operation screen 100B, and the third operation screen 100C each display six icons 110. The number of icons 110 displayed on the operation screen 100 is not limited to six. The number of icons 110 displayed on the operation screen 100 may be one or more. The operation screen 100 does not have to display the icon 110. The number of icons 110 displayed on each of the plurality of operation screens 100 may be the same or different. The number of icons 110 displayed on the operation screen 100 can be changed by user settings and the like.

FIGS. 3, 4, and 5 show a case where the multifunction machine 1 displays three operation screens 100, but the present disclosure is not limited to this. The number of operation screens 100 displayed by the multifunction machine 1 may be two or four or more. The control unit 50 sets the number of icons 110 corresponding to various functions based on the functions provided in the multifunction machine 1, and the display control unit 51 sets the number of operation screens 100 based on the set number of icons 110. The number of operation screens 100 may be set based on the user setting. The memory 40 stores the icon 110 to be displayed in association with each operation screen 100.

As shown in FIGS. 3, 4, and 5, the first background image 115A, the second background image 115B, and the third background image 115C are different from each other. FIGS. 3, 4, and 5 show a case where the background image 115 is changed by changing the pattern as a display mode. The background image 115 is set by the display control unit 51 for each operation screen 100. The background image 115 may be set for each operation screen 100 by user setting.

The first background image 115A displayed on the first operation screen 100A is different from the second background image 115B displayed on the second operation screen 100B. The user can easily determine whether the displayed operation screen 100 is the first operation screen 100A or the second operation screen 100B. The user can determine the operation screen 100 without checking the details of the icons 110 displayed on the operation screen 100.

The third background image 115C displayed on the third operation screen 100C is different from the first background image 115A displayed on the first operation screen 100A and the second background image 115B displayed on the second operation screen 100B. The user can easily determine whether the displayed operation screen 100 is the third operation screen 100C.

FIG. 5 shows a case where the third background image 115C is made different from the first background image 115A and the second background image 115B. The icons 110 displayed on the first operation screen 100A in FIG. 3 are related to an execution instruction. The icons 110 displayed on the second operation screen 100B in FIG. 4 and the third operation screen 100C in FIG. 5 are related to a setting instruction. When the third background image 115C is made the same as the second background image 115B, and made different from the first background image 115A, the user can determine whether the operation screen is an operation screen 100 for displaying the icons 110 related to the execution instruction or an operation screen 100 for displaying the icons 110 related to the setting instruction.

FIGS. 3, 4, and 5 show a case where the first background image 115A, the second background image 115B, and the third background image 115C are made different from each other by changing the pattern as the display mode of the background image 115. However, the present disclosure is not limited to this. The display control unit 51 makes the first background image 115A, the second background image 115B, and the third background image 115C different from each other by changing a color as a display mode of the background image 115. As an example, the display control unit 51 makes the first background image 115A a blue plain image, the second background image 115B a yellow plain image, and the third background image 115C a red plain image. The user can identify the displayed operation screen 100 by visually recognizing the background color of the operation screen 100. This makes it possible to improve the operability by the user of the multifunction machine 1.

The display control unit 51 makes the first background image 115A, the second background image 115B, and the third background image 115C different from each other by changing brightness as a display mode of the background image 115. As an example, the display control unit 51 displays the first background image 115A with the first brightness on the operation panel 30. The display control unit 51 displays, on the operation panel 30, the second background image 115B with second brightness brighter than the first brightness. The display control unit 51 displays the third background image 115C with third brightness darker than the first brightness on the operation panel 30. The user can identify the displayed operation screen 100 by visually recognizing the brightness of the operation screen 100.

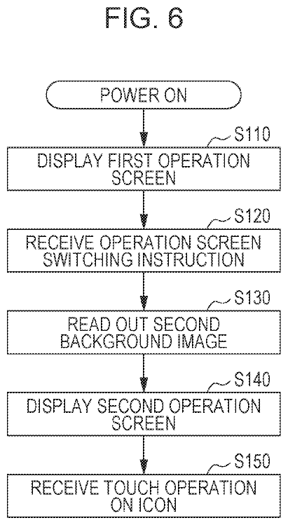

FIG. 6 shows a flowchart when switching the operation screen 100 displayed on the operation panel 30. The method of controlling a display of the multifunction machine 1 shown in FIG. 6 is performed by the processor 27 of the display control unit 51 reading the display control program 45 from the memory 40 and executing the display control program 45. When the user turns on the power of the multifunction machine 1, as shown in step S110 in FIG. 6, the display control unit 51 displays the first operation screen 100A on the operation panel 30. The timing at which the operation panel 30 displays the first operation screen 100A is not limited to when the power is turned on. When the multifunction machine 1 is provided with the power saving mode, the operation panel 30 may display the first operation screen 100A at the timing when the power saving mode is switched to the normal mode. When the display control unit 51 displays the first operation screen 100A on the operation panel 30, the display control unit 51 reads out the first background image 115A and the plurality of icons 110 stored in the memory 40. The first background image 115A and the plurality of icons 110 displayed on the first operation screen 100A are stored in the memory 40 in association with the first operation screen 100A in advance. When the first operation screen 100A is displayed on the operation panel 30, it is possible to receive a touch operation by the user on the plurality of icons 110 and the first screen switching instruction icon 120A displayed on the first operation screen 100A.

In a state where the operation panel 30 displays the first operation screen 100A, the multifunction machine 1 receives a switching instruction instructing the switching of the operation screen 100 as shown in step S120. The display control unit 51 receives a switching instruction when a predetermined operation is performed on the operation panel 30 as a user operation. The predetermined operation is a tap operation to the first screen switching instruction icon 120A displayed on the first operation screen 100A.

When the display control unit 51 receives the switching instruction, the display control unit 51 reads out the second background image 115B and the plurality of icons 110 associated with the second operation screen 100B from the memory 40 as shown in step S130. The second background image 115B and the plurality of icons 110 displayed on the second operation screen 100B are stored in the memory 40 in association with the second operation screen in advance.

The display control unit 51 reads out the second background image 115B and a plurality of icons from the memory 40 to display the second operation screen 100B on the operation panel 30 as shown in step S140. The second operation screen 100B displays the second background image 115B and the plurality of icons 110.

When the second operation screen 100B is displayed on the operation panel 30, the plurality of icons 110, a touch operation by user on the first screen switching instruction icon 120A, and the second screen switching instruction icon 120B displayed on the second operation screen 100B can be received as shown in step S150.

FIG. 6 shows a case where the first operation screen 100A is displayed in step S110 and the second operation screen 100B is displayed in step S140, but the present disclosure is not limited to this. The display control unit 51 may display the second operation screen 100B or the third operation screen 100C on the operation panel 30 in step S110. When the multifunction machine 1 is turned on, the operation screen 100 displayed on the operation panel 30 is stored in the memory 40 in advance. When the second operation screen 100B is displayed in step S110, the display control unit 51 can display the first operation screen 100A or the third operation screen 100C in step S140. When the third operation screen 100C is displayed in step S110, the display control unit 51 can display the second operation screen 100B in step S140.

When switching the operation screen 100, the display control unit 51 displays the operation screen 100 having different background images 115 on the operation panel 30. By visually recognizing the background image 115, the user can easily determine which operation screen 100 is displayed on the operation panel 30. This makes it possible to improve the operability by the user of the multifunction machine 1.

### Second Embodiment

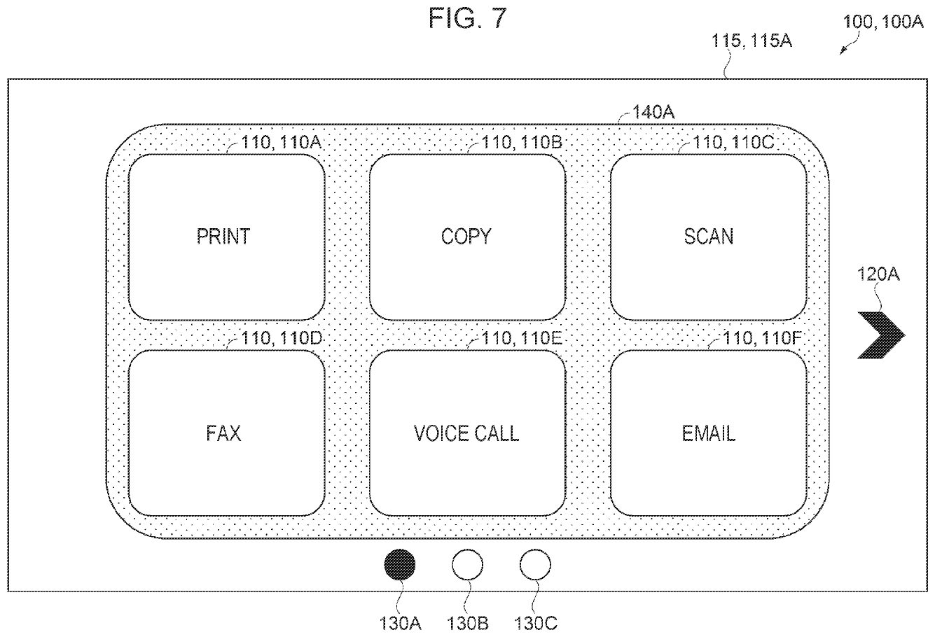

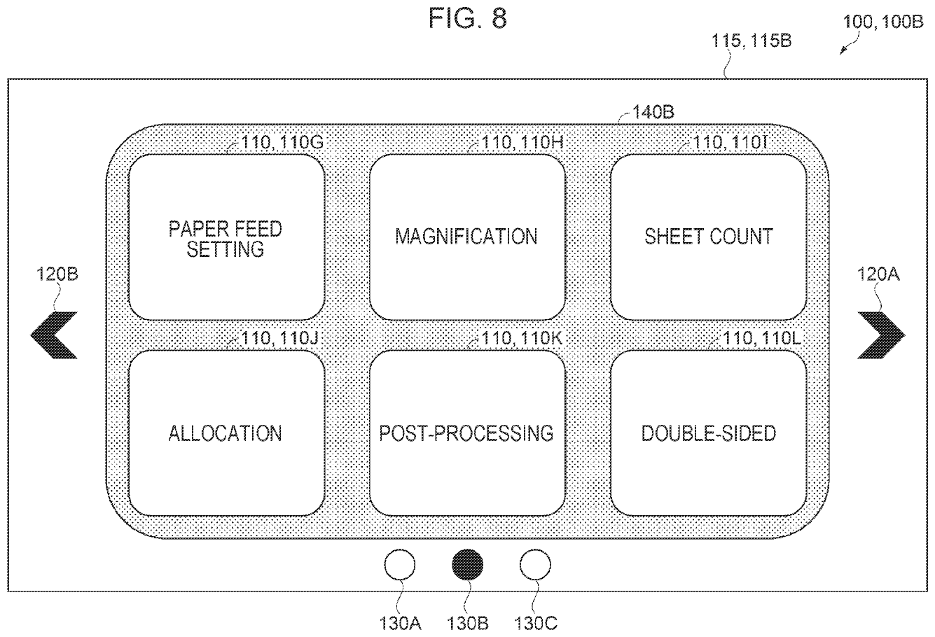

FIGS. 7 and 8 show the operation screen 100 of the second embodiment. FIG. 7 shows the first operation screen 100A of the second embodiment displayed on the operation panel 30. The plurality of icons 110 displayed on the first operation screen 100A in FIG. 7 are the same as the plurality of icons 110 displayed on the first operation screen 100A in FIG. 3. The first screen switching instruction icon 120A, the first position icon 130A, the second position icon 130B, and the third position icon 130C displayed on the first operation screen 100A in FIG. 7 are the same as the first screen switching instruction icon 120A, the first position icon 130A, the second position icon 130B, and the third position icon 130C displayed on the first operation screen 100A in FIG. 3, respectively.

The first background image 115A displayed on the first operation screen 100A in FIG. 7 is different from the first background image 115A displayed on the first operation screen 100A in FIG. 3. The first background image 115A in FIG. 7 has a first display image 140A in the background portion of the icons 110.

FIG. 8 shows the second operation screen 100B of the second embodiment displayed on the operation panel 30. The plurality of icons 110 displayed on the second operation screen 100B in FIG. 8 are the same as the plurality of icons 110 displayed on the second operation screen 100B in FIG. 4. The first screen switching instruction icon 120A, the second screen switching instruction icon 120B, the first position icon 130A, the second position icon 130B, and the third position icon 130C displayed on the second operation screen 100B in FIG. 8 are the same as the first screen switching instruction icon 120A, the second screen switching instruction icon 120B, the first position icon 130A, the second position icon 130B, and the third position icon 130C in FIG. 4, respectively.

The second background image 115B displayed on the second operation screen 100B in FIG. 8 is different from the second background image 115B displayed on the second operation screen 100B in FIG. 4. The second background image 115B in FIG. 8 has a second display image 140B in the background portion of the icon 110. The first display image 140A and the second display image 140B are included in the display image. The display image is stored in the memory 40 in association with the background image 115.

The first display image 140A included in the first background image 115A is different from the second display image 140B included in the second background image 115B. The display control unit 51 makes the background images 115 different from each other by changing the display images included in the background images 115. By visually recognizing the display image displayed on the operation screen 100, the user can determine whether the operation screen 100 displayed on the operation panel 30 is the first operation screen 100A or the second operation screen 100B. This makes it possible to improve the operability by the user of the multifunction machine 1.

Part of each of the background images 115 has a different display between the two background images 115 in FIGS. 7 and 8, but the present disclosure is not limited to this. When each background image 115 can be distinguished, the display image may be an image representing the entire background image 115, and the type of the display image is not limited. The display image may be a photograph, an illustration image, or the like. The display image may be registered in the multifunction machine 1 by the user.

### Third Embodiment

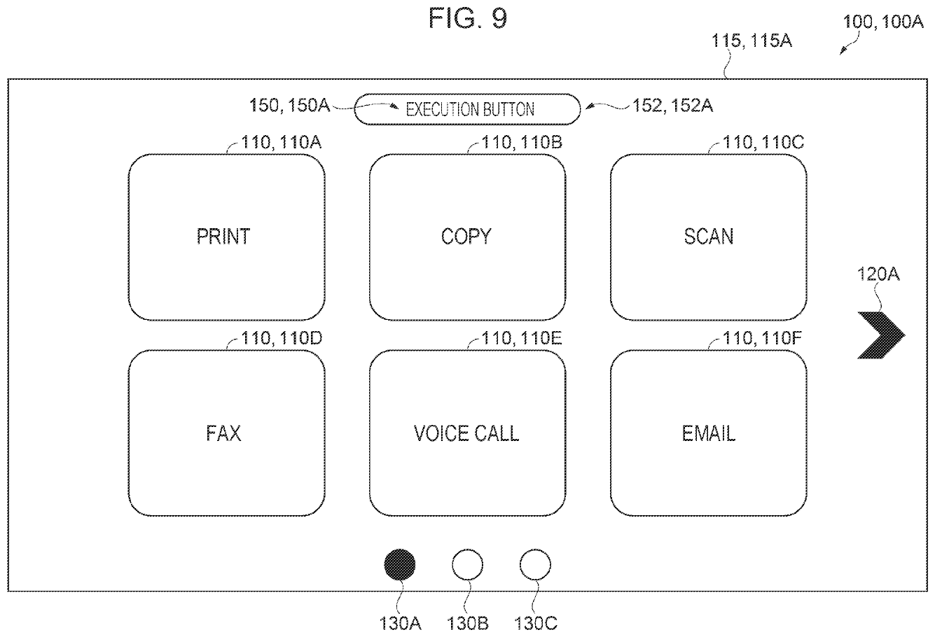

FIGS. 9, 10, and 11 show the operation screen 100 of the third embodiment. FIG. 9 shows the first operation screen 100A of the third embodiment displayed on the operation panel 30. The plurality of icons 110 displayed on the first operation screen 100A in FIG. 9 are the same as the plurality of icons 110 displayed on the first operation screen 100A in FIG. 3. The first screen switching instruction icon 120A, the first position icon 130A, the second position icon 130B, and the third position icon 130C displayed on the first operation screen 100A in FIG. 9 are the same as the first screen switching instruction icon 120A, the first position icon 130A, the second position icon 130B, and the third position icon 130C displayed on the first operation screen 100A in FIG. 3, respectively.

The first background image 115A displayed on the first operation screen 100A in FIG. 9 is different from the first background image 115A displayed on the first operation screen 100A in FIG. 3. The first background image 115A in FIG. 9 has a first text 150A and a first text box 152A including the first text 150A. The first text 150A is an example of a text 150 and corresponds to an example of a first character string. The first text box 152A is an example of a text box 152. The frame line indicating the first text box 152A corresponds to an example of a first frame. The image in the first text box 152A corresponds to an example of a first frame image. The image composed of the first text 150A and the first text box 152A corresponds to an example of a first text image.

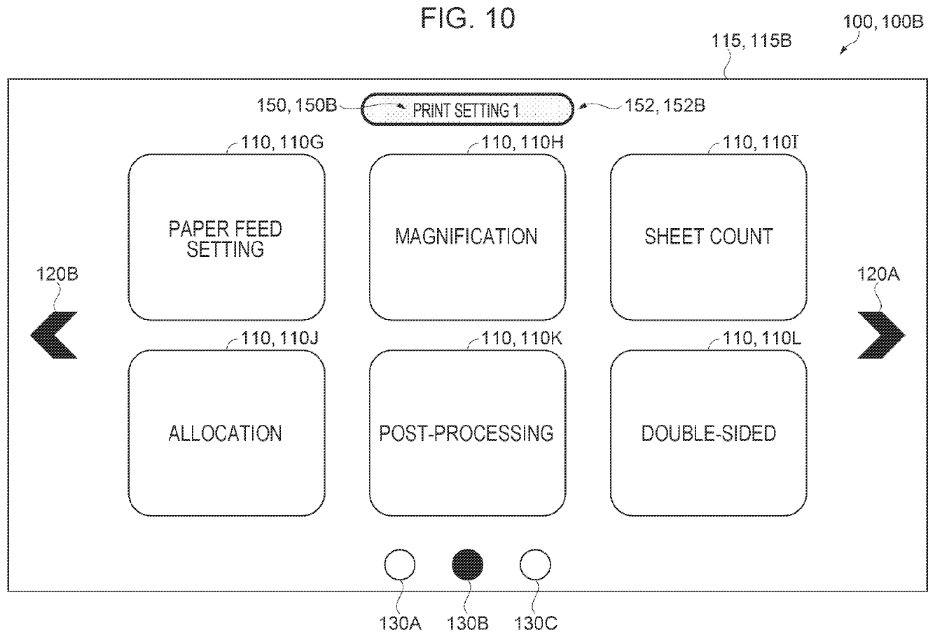

FIG. 10 shows the second operation screen 100B of the second embodiment displayed on the operation panel 30. The plurality of icons 110 displayed on the second operation screen 100B in FIG. 10 are the same as the plurality of icons 110 displayed on the second operation screen 100B in FIG. 4. The first screen switching instruction icon 120A, the second screen switching instruction icon 120B, the first position icon 130A, the second position icon 130B, and the third position icon 130C displayed on the second operation screen 100B in FIG. 10 are the same as the first screen switching instruction icon 120A, the second screen switching instruction icon 120B, the first position icon 130A, the second position icon 130B, and the third position icon 130C in FIG. 4, respectively.

The second background image 115B displayed on the second operation screen 100B in FIG. 10 is different from the second background image 115B displayed on the second operation screen 100B in FIG. 4. The second background image 115B in FIG. 10 has a second text 150B and a second text box 152B including the second text 150B. The second text 150B is an example of the text 150 and corresponds to an example of a second character string. The second text box 152B is an example of the text box 152. The frame line indicating the second text box 152B corresponds to an example of a second frame. The image in the second text box 152B corresponds to an example of a second frame image. The image composed of the second text 150B and the second text box 152B corresponds to an example of a second text image.

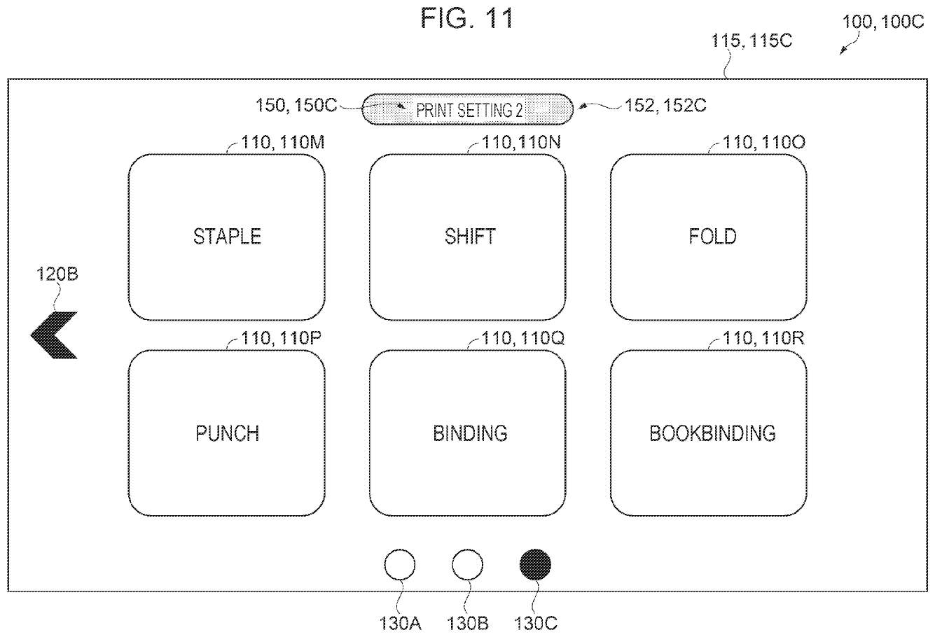

FIG. 11 shows the third operation screen 100C of the third embodiment displayed on the operation panel 30. The plurality of icons 110 displayed on the third operation screen 100C in FIG. 11 are the same as the plurality of icons 110 displayed on the third operation screen 100C in FIG. 5. The second screen switching instruction icon 120B, the first position icon 130A, the second position icon 130B, and the third position icon 130C displayed on the third operation screen 100C in FIG. 11 are the same as the second screen switching instruction icon 120B, the first position icon 130A, the second position icon 130B, and the third position icon 130C in FIG. 5, respectively.

The third background image 115C displayed on the third operation screen 100C in FIG. 11 is different from the third background image 115C displayed on the third operation screen 100C in FIG. 5. The third background image 115C in FIG. 11 has a third text 150C and a third text box 152C including the third text 150C. The third text 150C is an example of the text 150 and corresponds to an example of a third character string. The third text box 152C is an example of the text box 152. The frame line indicating the third text box 152C corresponds to an example of a third frame. The image in the third text box 152C corresponds to an example of a third frame image. The image composed of the third text 150C and the third text box 152C corresponds to an example of a third text image. The first text 150A, the second text 150B, and the third text 150C are included in the plurality of texts 150, and are stored in the memory 40 in association with each of the background images 115. The first text box 152A, the second text box 152B, and the third text box 152C are included in the plurality of texts 150 and are stored in the memory 40 in association with each of the background images 115.

The first background image 115A displayed on the first operation screen 100A in FIG. 9, the second background image 115B displayed on the second operation screen 100B in FIG. 10, and the third background images 115C displayed on the third operation screen 100C in FIG. 11 are different from each other. The first text 150A included in the first background image 115A, the second text 150B included in the second background image 115B, and the third text 150C included in the third background image 115C are different from each other. Further, the first text box 152A included in the first background image 115A, the second text box 152B included in the second background image 115B, and the third text box 152C included in the third background image 115C are different from each other. By visually recognizing the text 150 or a text box 152 included in the background image 115 displayed on the operation screen 100, the user can easily determine which operation screen 100 the operation screen 100 displayed on the operation panel 30 is. This makes it possible to improve the operability by the user of the multifunction machine 1.

FIGS. 9, 10, and 11 show cases where the text 150 included in the background image 115 has different texts and the text box 152 included in the background image 115 has different text boxes but the present disclosure is not limited to this. Either the text 150 or the text box 152 may have different texts or text boxes, respectively. The text 150 may have different fonts, character sizes, character colors, and the like. In FIGS. 9, 10, and 11, the text box 152 has different frames and different internal patterns. The frame of the first text box 152A in FIG. 9 and the frame of the second text box 152B in FIG. 10 have different frame line thicknesses, but the present disclosure is not limited to a change in the frame line thickness. The display control unit 51 may make the frame of the first text box 152A in FIG. 9 and the frame of the second text box 152B in FIG. 10 have different border colors. The color representing the border of the first text box 152A corresponds to an example of a first frame color, and the color representing the border of the second text box 152B corresponds to an example of a second frame color. The frame of the text box 152 can be changed in color, line thickness, line type, and the like. The color of the inside of the text box 152 may be changed.

The text 150 and the text box 152 are set by the user setting. When the first text 150A and the second text 150B are set by the user, the display control unit 51 compares the first text 150A with the second text 150B. When the set first text 150A and the second text 150B match, the display control unit 51 may display, on the operation panel 30, a notification of an instruction to change either the first text 150A or the second text 150B. When the set first text 150A and the second text 150B match, the display control unit 51 may cause the first text box 152A and the second text box 152B to be different from each other.

As described above, the multifunction machine 1 makes the first background image 115A different from the second background image 115B, so that the user can determine which operation screen is displayed by looking at the first background image 115A or the second background image 115B. The user can easily understand the displayed operation screen. This makes it possible to improve the operability by the user of the multifunction machine 1.

As shown in FIGS. 3 and 4, the display control unit 51 makes the first background image 115A and the second background image 115B different from each other by changing the display mode. The user can identify the displayed operation screen 100 by checking the display mode of the background image 115.

The display mode is the color of each of the first background image 115A and the second background image 115B. The display control unit 51 makes the first background image 115A and the second background image 115B different from each other by making the first color representing the first background image 115A different from the second color representing the second background image 115B. The user can identify the displayed operation screen 100 by checking the background color of the operation screen 100.

The display mode is the brightness of each of the first background image 115A and the second background image 115B. The display control unit 51 makes the first brightness representing the first background image 115A different from the second brightness representing the second background image 115B. The user can identify the displayed operation screen 100 by checking the brightness of the operation screen 100.

As shown in FIGS. 9 and 10, the first background image 115A has the first text image including the first character string, and the second background image 115B has the second text image including the second character string. The display control unit 51 makes the first background image 115A and the second background image 115B different from each other by making the first character string and the second character string different from each other. The user can identify the displayed operation screen 100 by checking the character string displayed in each operation screen 100.

The first text image has the first frame surrounding the first character string and the first frame image indicating the inside of the first frame, and the second text image has the second frame surrounding the second character string and the second frame image indicating the inside of the second frame. The display control unit 51 makes the first background image 115A and the second background image 115B different from each other by making the first frame color representing the first frame different from the second frame color representing the second frame. The user can identify the displayed operation screen 100 by checking the image or the color around the character string displayed on the operation screen 100.

As shown in FIG. 5, the operation panel 30 displays the third operation screen 100C including the plurality of icons 110 and the third background image 115C. The display control unit 51 makes the third background image 115C different from the first background image 115A and the second background image 115B. When displaying the third operation screen 100C, the multifunction machine 1 displays, on the third operation screen 100C, the third background image 115C that is different from the first background image 115A displayed on the first operation screen 100A and the second background image 115B displayed on the second operation screen 100B, so that the user can distinguish the third operation screen 100C from the first operation screen 100A and the second operation screen 100B.

As shown in FIG. 6, the method of controlling a display of the multifunction machine 1 includes making the first background image 115A in the first operation screen 100A and the second background image 115B in the second operation screen 100B different from each other. The user can determine which operation screen 100 is displayed by looking at the first background image 115A or the second background image 115B. The user can easily understand the displayed operation screen 100. This makes it possible to improve the operability by the user of the multifunction machine 1.

As shown in the above-described embodiment, the display control program 45 makes the first background image 115A in the first operation screen 100A and the second background image 115B in the second operation screen 100B different from each other, so that the user can determine which operation screen 100 is displayed by looking at the first background image 115A or the second background image 115B. The user can easily understand the displayed operation screen 100. This makes it possible to improve the operability by the user of the multifunction machine 1.

The function of the display control unit 51 may be implemented by one or more processors or one or more semiconductor chips. For example, the display control unit 51 is configured to further include an auxiliary processing device (co-processor) such as a system-on-a-chip (SoC), a micro control unit (MCU), and a field-programmable gate array (FPGA). The display controller may cooperate with both the CPU and the auxiliary processing device, or may selectively use one of the two to perform various kinds of control.

The processing unit of the flowchart in FIG. 6 is divided according to the main processing content in order to make the process of the multifunction machine 1 easy to understand, and is not limited by the method and name of division of the processing unit. The process of each step may be divided into more processing units depending on the processing content. One processing unit may be divided so as to include more processes. The order of processes may be appropriately changed as long as it does not interfere with the purpose.

The display control method of the present embodiment is implemented by the processor 27 included in the multifunction machine 1 executing the display control program 45, and the display control program 45 executed by the processor 27 to implement the display control method is configured in the form of a recording medium readable by a computer or a transmission medium that transmits the display control program 45. As the recording medium, a magnetic or optical recording medium or a semiconductor memory device can be used. Examples of the medium include portable or fixed recording media such as a flexible disc, an HDD, a compact disk read only memory (CD-ROM), a digital versatile disc (DVD), a Blu-ray (registered trademark) disc, a magneto-optical disk, a flash memory, and a card-type recording medium. The recording medium may be a non-volatile storage device such as a RAM, a ROM, or an HDD included in the multifunction machine 1.

What is claimed is:

1. A multifunction machine comprising: a reading unit that reads a document;
a printing unit that performing printing on a medium;
an operation panel that receives a user operation to display a first operation face including a plurality of icons and a first background image and a second operation face including a plurality of icons and a second background image; and
a display controller that controls a display of the operation panel, wherein the display controller switches between the first operation face and the second operation face based on the user operation, and wherein the display controller makes the first background image and the second background image different from each other.

2. The multifunction machine according to claim 1, wherein
the display controller
makes the first background image and the second background image different from each other by changing a display mode.

3. The multifunction machine according to claim 2, wherein
the display controller
makes the first background image and the second background image different from each other by making a first color representing the first background image and a second color representing the second background image different from each other.

4. The multifunction machine according to claim 2, wherein
the display controller
makes the first background image and the second background image different in brightness from each other by making first brightness representing the first background image and second brightness representing the second background image different from each other.

5. The multifunction machine according to claim 1, wherein
the first background image has a first text image including a first character string, wherein
the second background image has a second text image including a second character string, and wherein
the display controller
makes the first background image and the second background image different from each other by making the first character string and the second character string different from each other.

6. The multifunction machine according to claim 5, wherein
the first text image has a first frame surrounding the first character string and a first frame image indicating an inside of the first frame, wherein
the second text image has a second frame surrounding the second character string and a second frame image indicating an inside of the second frame, and wherein
the display controller
makes the first background image and the second background image different from each other by making a first frame color representing the first frame and a second frame color representing the second frame different from each other.

7. The multifunction machine according to claim 1, wherein
the operation panel displays a third operation face including a plurality of the icons and a third background image, and wherein
the display controller
makes the third background image different from the first background image and the second background image.

8. A method of controlling a display of a multifunction machine including an operation panel, the method comprising:
displaying a first operation face including a plurality of icons and a first background image;
receiving a user operation and switching an operation face from the first operation face to a second operation face including a plurality of icons and a second background image different from the first background image; and
displaying the second operation face on the operation panel.

9. A non-transitory computer-readable storage medium storing a display control program, the display control program causing a processor of a multifunction machine including an operation panel that displays an operation face to execute a method, the method comprising:
displaying, as the operation face, a first operation face including a plurality of icons and a first background image on the operation panel;
receiving a user operation to switch the operation face of the operation panel from the first operation face to a second operation face including a plurality of icons and a second background image different from the first background image; and
displaying the second operation face on the operation panel.
